(19) United States
(12) Patent Application Publication
(10) Pub. No.: US 2010/0171505 A1
(43) Pub. Date: Jul. 8, 2010

(54) Supplemental air system for a portable, instrinsically safe, flame ionization detector (FID) device

(76) Inventors: James Norgaard, Marblehead, MA (US); Gary Richard, Brookline, MA (US); Joseph A. Rebeiro, Freetown, MA (US)

Correspondence Address: Iandiorio Teska & Coleman, 260 Bear Hill Road, Waltham, MA, 02451, US

(21) Appl. No.: 12/592,113

(22) Filed: Nov. 19, 2009

Related U.S. Application Data
(60) Provisional application No. 61/200,269, filed on Nov. 26, 2008.

(51) Int. Cl. G01N 27/62

(52) U.S. Cl. 324/468

(57) ABSTRACT

A supplemental air system for a portable, intrinsically safe (IS), flame ionization detector (FID) device includes a portable, intrinsically safe, FID device and a supplemental air system coupled to the FID device configured to store compressed air and deliver a flow of regulated air to the FID device as needed.

### RELATED APPLICATIONS

This application claims benefit of and priority to U.S. Provisional Application Ser. No. 61/200,269 filed Nov. 26, 2008 under 35 U.S.C. §§119, 120, 363, 365, and 37 C.F.R. §1.55 and §1.78, incorporated herein by this reference.

### FIELD OF THE INVENTION

This invention relates to a supplemental air system for a portable, intrinsically safe (IS), flame ionization detector (FID) device.

### BACKGROUND OF THE INVENTION

A portable (IS) FID device is often used in leak detection and repair (LDAR) applications, landfill gas monitoring, environmental assessments, and the like. Such a device can be used to detect volatile organic compounds (VOCs) and/or hazardous organic compounds produced from petro-chemical facilities, chemical plants, paint facilities, and similar type facilities which emit VOCs.

In the United States, a portable IS FID device needs to be certified as IS before it can be used. Underwriters Laboratory is a nationally approved testing laboratory which sets the standards and gives IS certification to portable FID devices.

A typical portable IS FID device can detect VOCs ranging from about 0.1 ppm to about 100,000 ppm. The FID device is typically a multi-piece instrument which includes at least a main body where the FID is housed, a hydrogen storage vessel, electronic circuitry, and a hand held probe coupled to a pump located with the housing of the FID device for sampling the VOCs. The FID device is typically battery powered, and has all required consumables on-board. The main body is typically worn in a backpack configuration or carried by a handle or a shoulder strap. The FID itself utilizes a hydrogen flame contained within the chamber of the FID. A sample is drawn into the FID chamber where it encounters the hydrogen flame. VOCs (if present) are ionized when they encounter the flame. The burning of VOCs in the sample causes the temporary generation of ions that affect a charge differential that is measured by electronic circuitry.

The operation of the FID is directly affected by the relative concentrations of hydrogen, oxygen, and the gaseous sample in the detector chamber of the FID. Should any of the three gas ranges go out of the normal range, e.g., oxygen at a concentration of 16% to 21%, the hydrogen flame in the FID will extinguish (“flame out”) and the portable IS FID device will not be able to produce VOC readings.

Because the hydrogen gas delivered to the FID is typically relatively pure and regulated and the intake of the sample is controlled by the pump, the flame out problem occurs when either the oxygen falls below the level needed to support combustion (e.g. at high altitude or in an anoxic environment), or when the gases being sampled exceed a concentration level that effectively renders the environment too rich to support combustion.

### SUMMARY OF THE INVENTION

This invention features a supplemental air system for a portable, intrinsically safe (IS), flame ionization detector (FID) device which includes a portable, intrinsically safe, FID device, and a supplemental air system coupled to the FID device which is configured to store compressed air and deliver a flow of regulated compressed air to the FID device as needed.

In one embodiment, the system may include an air storage vessel configured to store the compressed gas. The supplemental air system may be configured to deliver the flow of regulated air to the FID at high altitudes. The supplemental air system may be configured to deliver a flow of regulated air to the FID in an anoxic environment. The supplemental air system may be configured to deliver a flow of regulated air to the FID when the gaseous sample being tested exceeds a concentration level that is too rich to support combustion of the FID. The system may further include a manifold coupled to the compressed air storage vessel. The system may further include a high pressure regulator coupled to the manifold configured to reduce the pressure of the compressed air. The system may further include a low pressure regulator coupled to the manifold configured to further reduce the pressure of the compressed gas to a level which can be utilized by the FID. The system may further include an air solenoid controlled by electronic circuitry within the housing of the FID device, the air solenoid may be configured to regulate the flow of compressed gas to the FID at high altitudes in an anoxic environment, or when the gaseous sample exceeds a concentration level too rich to support combustion of the FID. The system may further include a quick release fitting coupled to the compressed air storage vessel configured to provide for re-filling of the compressed air storage vessel with compressed air.

This invention also features a supplemental air system for a portable, intrinsically safe, flame ionization detector including a portable, intrinsically safe, FID device and a supplemental air system coupled to the FID device which may be configured to store compressed air and deliver a flow of regulated air to the FID device at high altitudes and/or in an anoxic environment and/or when the gaseous sample being tested exceeds a concentration level that is too rich to support combustion of the FID device.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a three-dimensional front-top view of one embodiment of the supplement air system for portable IS FID device of this invention;

FIG. 2A is a three-dimensional view showing in further detail one embodiment of the FID enclosure in the enclosure shown in FIG. 1;

FIG. 2B is a three-dimensional assembly view of the FID shown in FIG. 2A;

FIG. 3 is a three-dimensional view of a probe which may be coupled to the portable IS FID device in FIG. 1;

FIG. 4 is a three-dimensional enlarged view of the portable IS FID device shown in FIG. 1 showing in further detail the hydrogen storage system used to deliver hydrogen to the FID;

FIG. 5 is a schematic block diagram showing the operation of the FID shown in FIG. 2A; and

FIG. 6 is an enlarged three-dimensional front view showing in further detail one embodiment of the various connections between the supplemental air system of this invention and the FID shown in FIG. 2A encased in the enclosure.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

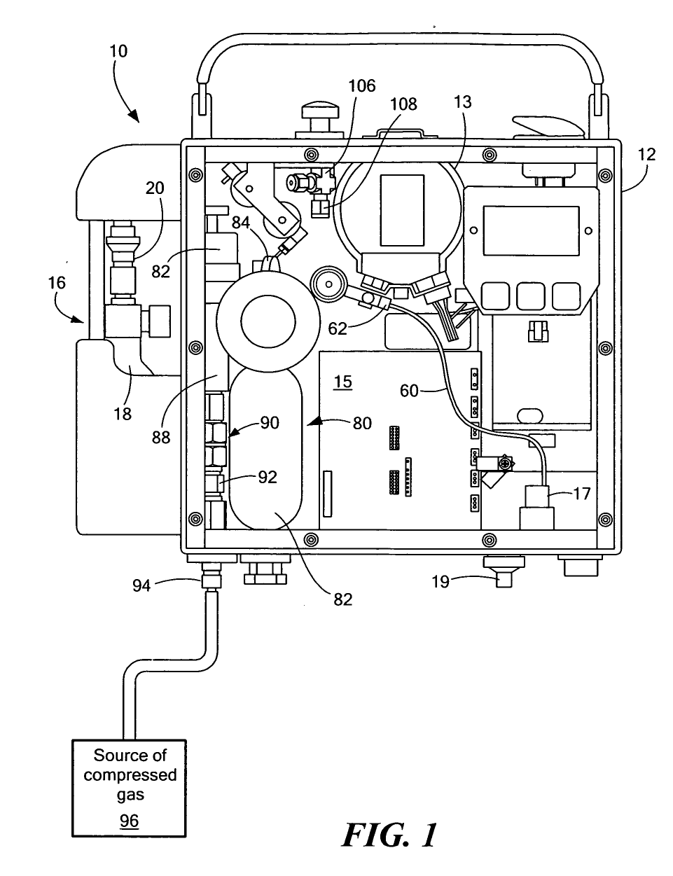

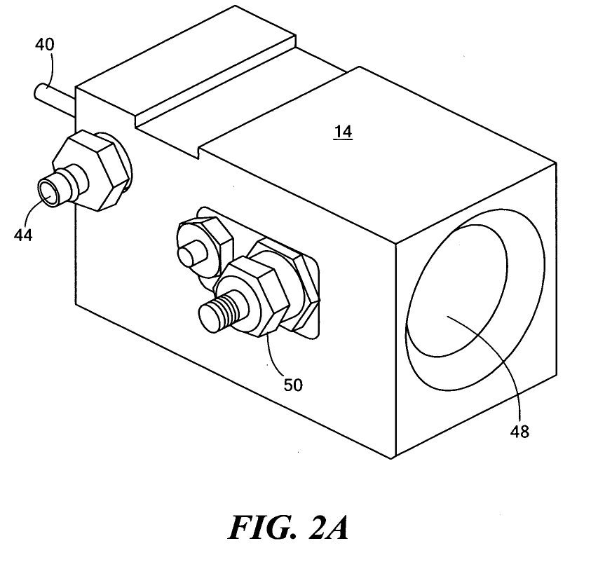

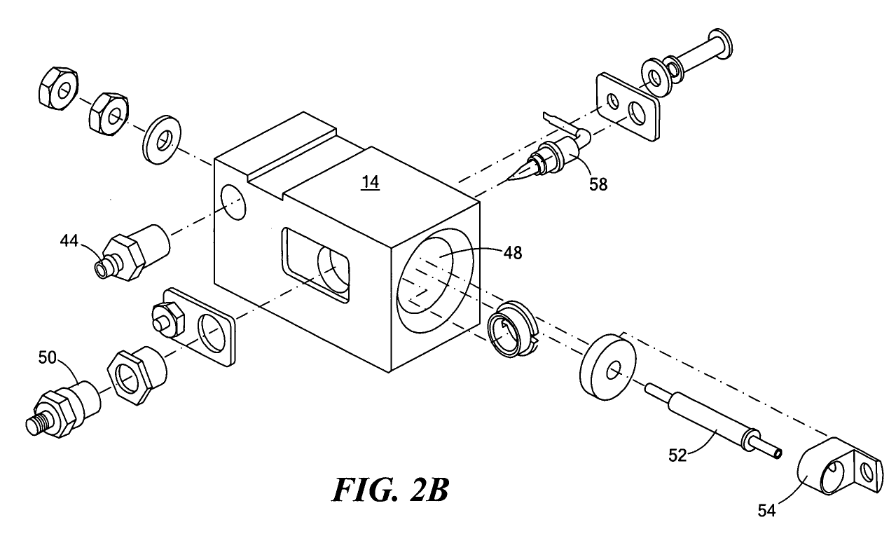

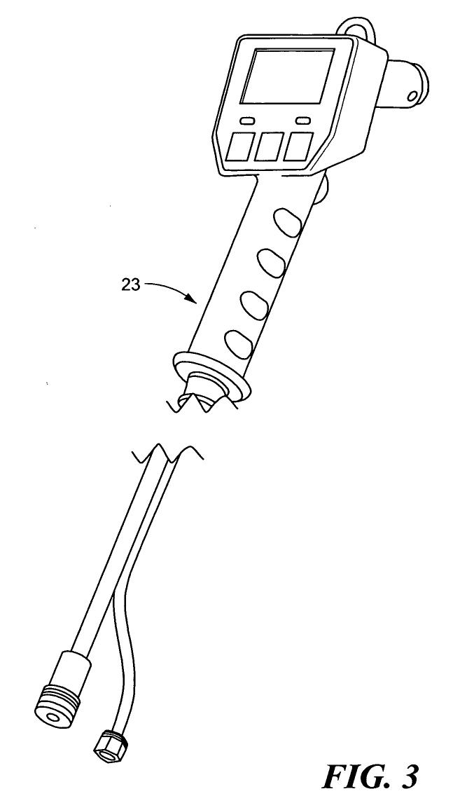

There is shown in FIG. 1 one embodiment of portable IS FID device 10 used to detect VOCs in LDAR applications and the like, as delineated in the Background section above. In this example, portable IS FID device 10 is a multi-piece instrument which includes at least main body 12, FID detector assembly enclosure 13 where the FID 14, FIGS. 2A-2B, is housed, electronic circuitry 15, FIG. 1, hydrogen storage system 16, and pump 17 which is coupled to quick connect fitting 19 connected to hand held probe 23, FIG. 3, which samples the VOCs at the facility being tested. Portable IS FID device 10, FIG. 1, is typically battery powered and has all required consumables on-board (not shown). Main body 12 is typically worn in a backpack configuration or may be carried by a handle or a shoulder strap. In one example, portable IS FID device 10 is commercially available from the assignee hereof, Photovac, Inc. (Waltham, Mass.). Further details of explosion-proof FID detector assembly 13 and hydrogen storage system 16, such as a metal hydride storage system, are disclosed in the co-pending applications “An Explosion-Proof Detector Assembly For A Flame Ionization Detector (FID)”, filed on an even date herewith, and “A Metal Hydride Storage System For A Portable, Intrinsically Safe, Flame Ionization Detector (FID) Device”, filed on an even date herewith, by one or more of the inventors hereof, incorporated by reference herein.

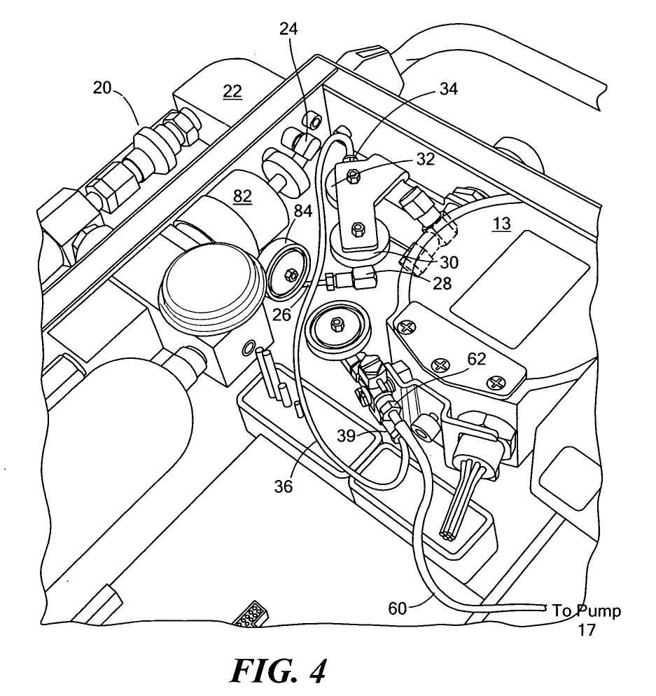

Hydrogen storage system 16 delivers a supply of regulated hydrogen gas to FID 14, FIGS. 2A-2B, inside enclosure 13, FIG. 1. In one example, hydrogen storage vessel 18 may be connected to quick release fitting 20 connected to manifold 22, FIG. 4. Fitting 24 coupled to manifold 22 connects to line 26. Line 26 is connected to fitting 28 on hydrogen regulator 30. Hydrogen regulator 30 is preferably coupled to another hydrogen regulator 32. Fitting 34 on hydrogen regulator 32 connects to line 36 which connects to hydrogen line fitting 39 which connects to fitting 39. Fitting 39 connects to a hydrogen line assembly, e.g., as disclosed in applicants' co-pending patent application entitled “An Explosion-Proof Detector Assembly For A Flame Ionization Detector (FID)” cited supra. The hydrogen line assembly is connected to fitting 40, FIG. 2A, which is coupled to FID 14 inside assembly enclosure 13, FIGS. 1 and 4 via a tube (not shown). Pump 17, FIG. 1, connects to probe 23, FIG. 3, via fitting 20. Pump 17, FIG. 1, pumps the gaseous sample being tested to FID 14, FIG. 2A, inside enclosure 13, FIG. 1, via line 60 coupled to fitting 62, shown in greater detail in FIG. 4. Fitting 62 connects to fitting 44, FIG. 2A on FID 14 via a tube (not shown).

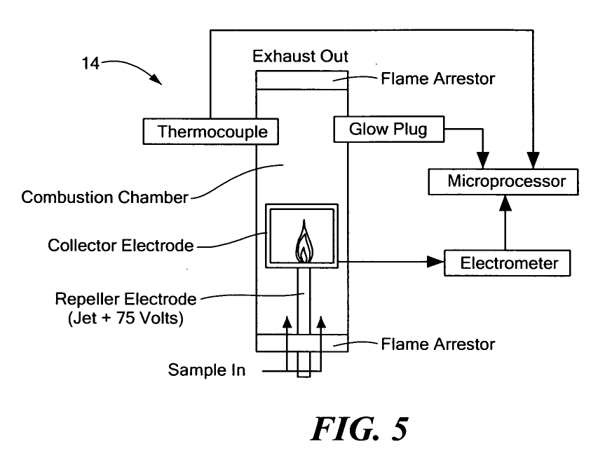

In operation, hydrogen is introduced to detector chamber 48, FIG. 2A, of FID 14. A hydrogen flame is initiated (lit) via ignitor 50 coupled to FID 14. Flame detector 58, FIG. 2B detects when the flame is lit. The sample is drawn into the FID chamber 48, FIG. 2A, via fitting 44 using a pump 17, FIG. 1. The sample encounters the hydrogen flame. VOCs (if present) are ionized when they encounter the flame. FID 14, FIGS. 2A-2B, has two electrodes inside chamber 48, e.g., hydrogen jet tube 52, FIG. 2B and collector 54 which have an opposite charge. The flame jet is positively charged to a potential of about 100VDC, while the detector electrode is at 0V and connected to the input of a high gain current amplifier on the internal circuitry 15, FIG. 1, of the FID device. The burning of VOCs produces ions, which in turn creates a current flow between the electrodes, and ultimately become an analog voltage which is roughly proportional to the amount of VOCs present in the sample. Portable IS FID device 10 preferably responds to virtually all carbon containing compounds in vapor form which is measured by portable IS FID device 10. FIG. 5 is a block diagram depicting the one exemplary operation of FID 14.

As discussed in the background, FID 14 may experience a flame out problem when either the oxygen falls below the level needed to support combustion, e.g. at high altitude or in an anoxic environment, or if the gases being sampled exceed a concentration level that effectively renders the environment too rich to support combustion.

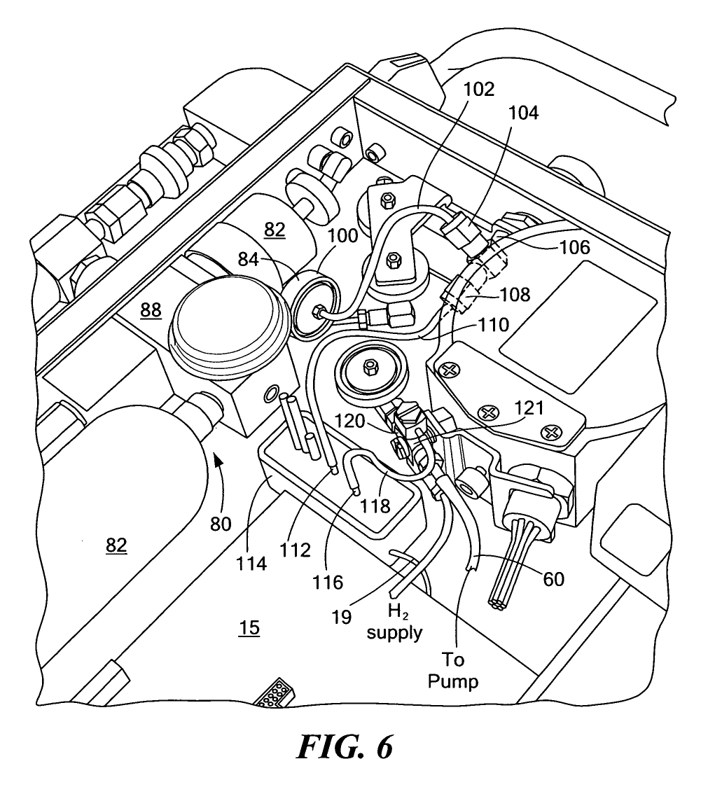

Supplemental air system 80, FIG. 1, of one embodiment of this invention provides a solution to the flame out problem associated with the FID of portable IS FID device 10. Supplemental air system 80 include compressed air storage vessel 82 configured to store about 150 mL of compressed “zero” air at about 1800 psi. As known by those skilled in the art, “zero” air has an extremely low amount of water and hydrocarbon content. In one example, compressed air storage vessel 82 is coupled to manifold 88, FIG. 6. High pressure regulator 82 coupled to manifold 88 is configured to reduce the 1800 psi pressure in vessel 82 to about 25 psi. Low pressure regulator 82 is also connected to manifold 88 and reduces the pressure output at fitting 100 to about 1 psi. Line 102 is connected to fitting 104 on turn on/turn off valve 106, shown in greater detail in FIG. 1. Valve 106 is opened to allow the regulated air to flow from vessel 82 and closed when vessel 82 is re-filled. Fitting 108 is connected to line 110, FIG. 6 which connects to fitting 112 on air solenoid 114. Fitting 116 is coupled to line 118 which connects to fitting 120. Fitting 120 is coupled to manifold 121 which connects to a sample assembly, e.g., as disclosed in applicants' co-pending patent application entitled “An Explosion-Proof Detector Assembly For A Flame Ionization Detector (FID)” cited supra. The air sample assembly connects to fitting 44 on FID 14, FIG. 2A via a tube (not shown). Air solenoid 114 is controlled by circuitry 15 by line 19 and is configured to deliver a regulated supply of compressed gas, e.g., at about 1 psi to FID 14, FIG. 2A, as needed, e.g., at high altitudes, in anoxic environment, or when gases being sampled exceed a concentration level that effectively renders the environment too rich to support combustion of the FID. One-way check valve 92, FIG. 1, is coupled to fittings 90 on one end and to quick release fitting 94 on the other end. Source of compressed gas 96 connects to quick release connector 94. In operation, compressed air storage vessel 82 is filled with “zero” compressed air from source of compressed air 96, e.g., about 150 mL of compressed air at about 1800 psi.

The result is supplemental air system 80 efficiently and effectively delivers a regulated supply of air to FID device 14 and prevents the oxygen level from falling below the level needed to support combustion at high altitudes in an anoxic environment, or when gases being sampled exceed a concentration level that effectively renders the environment too rich to support combustion.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A supplemental air system for a portable, intrinsically safe (IS), flame ionization detector (FID) device comprising:
a portable, intrinsically safe, FID device; and
a supplemental air system coupled to the FID device configured to store compressed air and deliver a flow of regulated air to the FID device as needed.

2. The system of claim 1 further including an air storage vessel configured to store the compressed gas.

3. The system of claim 1 in which the supplemental air system is configured to deliver the flow of regulated air to the FID at high altitudes.

4. The system of claim 1 in which the supplemental air system is configured to deliver the flow of regulated air to the FID in an anoxic environment.

5. The system of claim 1 in which the supplemental air system is configured to deliver the flow of regulated air to the FID when the gaseous sample being tested exceeds a concentration level that is too rich to support combustion of the FID.

6. The system of claim 1 further including a manifold coupled to the compressed air storage vessel.

7. The system of claim 1 further including a high pressure regulator coupled to the manifold configured to reduce the pressure of the compressed air.

8. The system of claim 7 further including a low pressure regulator coupled to the manifold configured to further reduce the pressure of the compressed gas to a level which can be utilized by the FID.

9. The system of claim 1 further including an air solenoid coupled to the low pressure regulator controlled by electronic circuitry within the housing of the FID device, the air solenoid configured to regulate the flow of compressed air to the FID at high altitudes.

10. The system of claim 1 further including an air solenoid controlled by electronic circuitry within the housing of the FID device, the air solenoid configured to regulate the flow of compressed air to the FID in an anoxic environment.

11. The system of claim 1 further including an air solenoid controlled by electronic circuitry within the housing of the FID device, the air solenoid configured to regulate the flow of compressed air to the FID when a gaseous sample exceeds a concentration level too rich to support combustion of the FID.

12. The system of claim 1 further including a quick release fitting coupled to the compressed air storage vessel configured to provide for re-filling of the compressed air storage vessel with compressed air.

13. A supplemental air system for a portable, intrinsically safe, flame ionization detector comprising:
a portable, intrinsically safe, FID device; and
a supplemental air system coupled to the FID device configured to store compressed air and deliver a flow of regulated air to the FID device at high altitudes and/or in an anoxic environment and/or when the gaseous sample being tested exceeds a concentration level that is too rich to support combustion of the FID device.
